(19) United States
(12) Patent Application Publication
(10) Pub. No.: US 2025/0180376 A1
(43) Pub. Date: Jun. 5, 2025

(54) METHOD FOR CALIBRATING AND DETERMINING POSITION DATA OF AN INERTIAL MEASUREMENT UNIT, TRAINING SYSTEM, AND MEDICAL INSTRUMENT COMPRISING AN INERTIAL MEASUREMENT UNIT

(71) Applicant: B. Braun New Ventures GmbH, Freiburg im Breisgau (DE)

(72) Inventor: Jean Stawiaski, Kirchzarten (DE)

(21) Appl. No.: 18/836,875

(22) PCT Filed: Feb. 9, 2023
(86) PCT No.: PCT/EP2023/053186

§ 371 Date: Aug. 8, 2024

(30) Foreign Application Priority Data
Feb. 11, 2022 (DE) 10 2022 103 249.3

(51) Int. Cl. G01C 25/00; G06T 7/70

(52) U.S. Cl. CPC G01C 25/005; G06T 7/70; G06T 2207/20081; G06T 2207/20084

(57) ABSTRACT

A method for calibrating and predicting at least position data of an inertial measurement unit (IMU) includes moving the IMU by a motorized system along a predefined trajectory in space; capturing, during the movement, measured movement data by the IMU and providing the movement data to a control unit; capturing, during movement, a position and/or orientation of the IMU by a tracking system; linking/assigning the measured movement data to the captured position and/or orientation to obtain a training data set; training an AI system with the training data set to obtain an IMU calibration; capturing measured movement data of the IMU as input for the trained AI system, and outputting, based on the input movement data, a position and/or orientation of the IMU by the trained AI system. The method can be used with a training system, a medical instrument, a computer-readable storage medium and a training data set.

### CROSS-REFERENCE TO RELATED APPLICATIONS

This application is the United States national phase entry of International Application No. PCT/EP2023/053186, filed on Feb. 9, 2023, and claims priority to German Application No. 10 2022 103 249.3, filed on Feb. 11, 2022. The contents of International Application No. PCT/EP2023/053186 and German Application No. 10 2022 103 249.3 are incorporated by reference herein in their entireties.

### FIELD

The present disclosure relates to a method for training and calibrating and for predicting or determining at least one position or position data of an inertial measurement unit. In addition, the present disclosure relates to a training system including an inertial measurement unit, a medical instrument with an inertial measurement unit, a computer-readable storage medium, a computer program and a training data set.

### BACKGROUND

In endoscopic surgeries, navigation within a patient's body represents a major challenge. Optical navigation systems with an optical tracking system, for example, only have a limited view and lose their function of determining position or orientation if a line of sight to the tracked object is interrupted. In addition, there are limitations in terms of adequate ergonomics for the instruments used, which are caused, for example, by bulky trackers. As a result, optical navigation systems are very poorly suited for use in endoscopic surgeries.

Efforts are being made to use inertial measurement units (IMU) for navigation in the field of medical technology. Inertial measurement units have the decisive advantage that they do not involve any visual problems and can be integrated into various systems or products without having an extremely negative impact on the ergonomics of these products.

However, inertial measurement units still have significant disadvantages that currently prevent their use in a surgical environment or at least make it very difficult. Although inertial measurement units allow acceleration and orientation or rotation rates to be detected, they do not provide any global, absolute position information. According to mathematical theory, the relative position of the IMU vis-à-vis an initial/start position can be calculated from the acceleration data measured by the inertial measurement unit (hereinafter only referred to as IMU) by double integration. However, calculating the position from acceleration data by integration is very sensitive to measurement errors, as the errors continue and even increase over time. A minor error at the beginning of the measurement increases over the path of the IMU. Double integration of acceleration data has shown to lead to significant errors in position determination over time. In addition, orientation data is also dependent on the calibration of the sensors and other interferences. These effects make it difficult to achieve high accuracy in orientation measurements.

In the field of medical technology, cost and size in particular play a decisive role. A large and relatively precise inertial measurement unit, as is used in the field of aviation, for example, is not suitable for use in a surgical procedure. Semiconductor sensors are of particular interest as inertial measurement units, as they are small and inexpensive. However, acceleration-based position and speed estimates from inexpensive sensors are generally very error-prone. One of the reasons for this is that the orientation of the sensors must be determined very precisely in order to be able to distinguish the effects of gravity from an actual physical acceleration of the sensors. Even slight errors in the orientation estimation lead to high errors in the measured acceleration. These errors lead to even greater errors in the position estimate due to double integration.

Without additional external sensors, it is often not possible to make an accurate position estimate. The acceleration sensors measure both the physical acceleration and the influence of normal forces caused by gravity. Therefore, the movement data imperatively exhibit an influence of gravitational acceleration. Furthermore, the integration is performed using a finite time step, which also requires a precisely determined time measurement.

Since a position determination only by integration of the movement data of an IMU does not provide sufficient accuracy, the prior art suggests supplementing the movement data of the IMU with further data.

It is known from the prior art to use algorithms as filters to calibrate or smooth data. For example, it is known from current research in an unrelated field to equip a vehicle with an IMU. The IMU captures movement data while the vehicle is moving. At the same time, the (global) position of the vehicle is tracked by GPS, resulting in redundant detection. It is also known from the prior art to use Kalman filters for estimating and smoothing an IMU.

However, there is no known way in the prior art to individually calibrate an IMU and to calculate and determine or predict a precise position of an IMU in space.

### SUMMARY

It is an object of the present disclosure to avoid or at least reduce the disadvantages of the prior art and in particular to provide a method, a training system, a medical instrument, a computer-readable storage medium, a computer program and a training data set in order to determine at least one position of an IMU in space as precisely as possible on the basis of measured movement data. A further object is to determine a link between measured movement data, in particular of measured acceleration and measured orientation, and at least position data of the IMU without specifying mathematical formulae.

A basic idea of the present disclosure is therefore to use an AI system (artificial intelligence system) to establish a link between the measured (raw) movement data of the inertial measurement unit (IMU), in particular the measured acceleration data and the measured rotation rates or the measured orientation, to at least position data. For this purpose, the AI system is trained accordingly.

The trained AI system is ultimately able to act as a kind of converter between an input and an output, converting the measured movement data as input into (at least) one precise position specification or into precise position data of the IMU as output and thus at least predicting the position. By this, a type of calibration of the IMU is achieved which is customizable and does not require any special predetermined mathematical formulae.

The objectives of the present disclosure thus are solved with regard to a method for calibrating and predicting at least position data of an inertial measurement unit (IMU) as follows. Specifically, the method comprises the following steps. The IMU is actively moved in space along a trajectory, in particular a predefined trajectory, by a motorized system or actuator system. This means that at least the position of the IMU, in particular the position, the orientation and also preferably an acceleration, changes along the trajectory. In particular, the trajectory can be defined at the beginning of the movement in order to follow a type of target trajectory. During this movement, measured movement data are captured by the IMU and the movement data are provided to a control unit. The IMU is therefore used to read out the internally measured (raw) movement data along the trajectory and provide it to the control unit. In addition, a tracking system captures a position and/or an orientation, in particular a position and an orientation (i.e. a location), of the IMU during movement along the trajectory. A further step of the method can preferably be the linking or assignment of the measured movement data to the captured positions, in particular the positions and orientations, in order to obtain a training data set. An AI system (artificial intelligence system) is trained with the training data set in order to obtain a trained AI system and thus an IMU calibration. This means that the trained AI system is ready for an application with just one input. Finally, in the method, the measured movement data of the IMU are captured as input for the trained AI system and a position and/or orientation, in particular a location, of the IMU is output by the trained AI system based on the input movement data. In particular, the position and/or orientation, especially the location, of the IMU is provided to a navigation system, which can output the position and/or orientation, for example by an output device.

The IMU is fixed or mounted to the motorized system. The motorized system moves through space along the trajectory, in particular on the predetermined/predefined trajectory. Hence, the IMU is mounted to the motorized system such that the IMU can be moved through space along the trajectory with the aid of the motorized system and can change its position, in particular its position and orientation. The IMU captures the measured movement data during the movement of the motorized system. The movement data is preferably an acceleration in three directions (a_x, a_y, a_z) and an orientation of the IMU around three directions, respectively, in particular in form of rotation rates or orientations around three axes (for example, around the X, Y, Z axes). In particular, six individual values thus are captured as movement data, three acceleration values and three rotation rate values. Preferably, a magnetic field moreover can be detected by the IMU.

While the IMU executes the movement along the trajectory by the motorized system, the position and/or orientation of the IMU is also captured by a tracking system in space. The tracking system in a way provides the captured absolute position and/or orientation (also referred to as position data) in space. The tracking system is preferably an optical tracking system or a mechanical-kinematic tracking system. As a result of the capturing of the measured movement data and the position data, two time-dependent data sets are available. The movement data and the position data are associated in such a way that the corresponding position and/or orientation is/are assigned to the movement data at specific points in time or time periods. This creates a linked (training) data set that assigns the movement data and the corresponding position data to each other.

The linked data set is used to train or teach the AI system. The linked data set is therefore the training data set for the AI system. The AI system is preferably an artificial neural network. The movement data is an input and the position and/or orientation is an output for the AI system. By training the AI system, the individual weightings of the neural network are adjusted in such a way that a connection or correlation between the movement data on the one hand and the position data on the other hand is determined without an explicit specification having to be made. This completes the training phase of the AI system. The trained AI system is essentially an IMU calibration. This means that the raw, captured, measured movement data in a way are individually corrected by the trained AI system and are associated with corresponding position data. For example, the influence of gravity and other disturbances can be removed from the raw data. In a subsequent step, the trained AI system is then used to provide a prediction for the position and/or orientation of the IMU in space for the measured movement data of the IMU. The present method or the trained AI system hence is able to determine the position and/or orientation of the IMU very precisely based on the measured movement data of the IMU. In particular, predictions for the position data of the IMU are output for one or more new trajectories that were not yet captured by the tracking system.

In summary, the essence of the disclosure is to use the IMU to capture measured movement data for trajectories, while the position and/or orientation are simultaneously captured by the tracking system. The captured data are used to train the AI system. Based on measured movement data along an unknown trajectory, the trained AI system can now predict/output the position and/or orientation during this trajectory without the need for position tracking of the IMU.

The method according to the disclosure has the following advantages. As explained above, the calculation of position and/or orientation from acceleration data by double integration leads to high calculation errors. The influence of gravitational acceleration leads to additional noise or interferences in the captured acceleration data. These problems are solved by the method according to the disclosure and the trained AI system, respectively. The trained AI system enables the most accurate possible prediction of the position and/or orientation of the IMU to be made from the captured movement data of the IMU. The learning process and the training of the AI system, respectively, can eliminate/exclude disturbances caused by the influence of gravitational acceleration and systematic calibration errors. Furthermore, the AI system can be adjusted to each single IMU individually. Moreover, trained AI systems can be provided for a specific class or quantity of IMUs. By eliminating the systematic measurement errors and accurately predicting the position and/or orientation of the IMU, small and inexpensive sensors can be used and still achieve sufficiently good accuracies. As a result, costs can be saved and the installation space on a medical instrument equipped with the IMU can be optimally utilized. An additional advantage is that it is simple, efficient and quick to generate sufficient training data for the AI system.

The problem of the present disclosure is further solved by a training system for calibrating (and predicting) at least position data of the inertial measurement unit (IMU). For this purpose, the training system has the IMU to be calibrated which captures measured movement data and provides it to a control unit. Furthermore, the training system has a motorized system that is adapted to move the IMU to be calibrated along a trajectory, in particular a predefined trajectory, in space. The training system also has a tracking system that is adapted to capture a position and/or orientation of the IMU and provide it to the control unit. The control unit is adapted to link the measured movement data with the captured position and/or orientation in order to obtain a training data set. Finally, the training system has an AI system that trains the control unit with the training data set in order to obtain a trained AI system for IMU calibration.

The IMU is therefore moved along the trajectory by the motorized system. The measured movement data during the movement are captured by the IMU. In the controlled environment, also the position and/or orientation of the IMU during movement is captured very accurately by the tracking system. The respectively captured data is linked by the control unit to generate the associated training data set. The AI system is trained using the generated training data set. The AI system is trained by the training system according to the disclosure in such a way that it calibrates the movement data of the IMU and can provide the best possible prediction for the position and/or orientation of the IMU based on captured movement data. The training system can therefore be used to train an AI system specifically for an individual IMU or a quantity of (almost) identical IMUs. This trained AI system, which is stored in particular on a computer-readable storage medium, can then be used together with the IMU for an application in a medical field, in particular for surgical navigation.

Furthermore, according to the present disclosure, the problem is solved by a medical, in particular surgical, instrument. The medical instrument has an inertial measurement unit (IMU) and moreover a trained AI system which is trained/adapted by a training system, in particular a training system according to the present disclosure, in order to obtain, through measured movement data of the IMU as input for the trained AI system, a position and/or orientation of the IMU by the trained AI system, based on the input movement data. The IMU is fixed to the medical instrument, in particular as a module, preferably to a distal tip of a medical instrument that is inserted intracorporeally during surgery, in order to determine the position and/or orientation as directly and immediately as possible. When the medical instrument is used and moved during surgery, the IMU captures the movement data. The medical instrument and with it the IMU can be moved along a new trajectory and the trained AI system can determine and output the position and/or orientation of the IMU using the measured movement data of the IMU as input. Thus, a user knows at any time where and/or in which orientation the IMU and thus the (in particular the distal tip of the) medical instrument is located globally in space.

Furthermore, the problem of the disclosure is solved by a computer-readable storage medium and by a computer program, each comprising instructions which, when executed by a computer, cause the computer to carry out the method steps of the method according to the disclosure.

Furthermore, the task of the disclosure is solved by a training data set for training and thus calibrating (and predicting) an IMU in that this training data set comprises, on the one hand, measured movement data of the IMU along a trajectory and, on the other hand, involves associated captured positions and/or orientations of the IMU along the trajectory. The training data set thus has the measured movement data as input and the position and/or orientation as output. The training data set can be used for training an AI system. In particular, a computer-readable storage medium may comprise the training data set according to the present embodiment. In particular, the training data set may be obtained by a training system according to the present disclosure.

The term “position” means a geometric position in three-dimensional space, which is indicated in particular by means of coordinates of a Cartesian coordinate system. In particular, the position can be indicated by the three coordinates X, Y and Z.

The term “orientation” in turn indicates an orientation (approximately at the position) in space. One could also say that the orientation indicates an orientation with a specification of direction or rotation in three-dimensional space. In particular, the orientation can be specified by means of three angles.

The term “position” includes both a position and an orientation. In particular, the position can be specified using six coordinates, three position coordinates X, Y and Z, and three angular coordinates for orientation.

The position or the orientation in the present case are regarded in particular relative to a coordinate system, preferably with reference to a coordinate system to be defined. For example, the tracking system can capture the position and orientation of the inertial measurement unit at a start time and then define this start data as a (start) coordinate system (i.e. positions zero, orientation zero) and then (continuously) track the position and orientation in this defined COS when the IMU moves. Alternatively, for example, also a local COS of the tracking system can be defined as COS, the start position and the start orientation of the IMU can be determined at a start time, and the position and orientation can then be tracked when the IMU moves relative to the start position and start orientation.

In the present case, the term “rotation rate”, as is also generally technically intended for an inertial measurement unit, refers to a rotational speed or three angular speeds, which can be measured. In particular, based on a start orientation (of e.g. the IMU) and a measured rotation rate (e.g. continuously over time), it is possible to infer an orientation at a further point in time, so that the rotation rate and orientation can be linked to one another via a functional relationship.

Advantageous further embodiments of the present disclosure are explained in particular below.

Preferably, in the step of capturing the measured movement data, at least an acceleration on the one hand and an orientation or rotation rate on the other hand are captured. Furthermore, an orientation to a magnetic field can preferably be captured. The acceleration is captured by one or a plurality of acceleration sensors. Preferably, the IMU has three orthogonal acceleration sensors in order to capture three accelerations in three different directions (a_x, a_y, a_z). The orientations and rotation rates, respectively, around the axes, in particular around the X, Y and Z axes, are captured by a gyroscope, in particular by three orthogonal gyro sensors. The IMU thus preferably has six sensors, three acceleration sensors and three gyro sensors. The IMU can also have just one acceleration sensor and one sensor for orientation, such as a gyro sensor. It is only necessary for the IMU to be able to capture the acceleration in three directions and the orientation in or around three directions. By capturing this movement data, the movement of the IMU can be sufficiently captured. The captured measured movement data is part of the training data set.

Preferably, the IMU is mounted to a medical instrument between the steps of training an AI system with the training data set and capturing measured movement data from the IMU as input for the trained AI system. This means that the IMU is removed from the motorized system and transferred to the medical instrument. Similarly, the trained AI system is transferred to the medical instrument or at least a data connection is established to the medical instrument so that the medical instrument can access the trained AI system. When the medical instrument is moved the IMU captures the movement data of this movement. While it was possible to capture a position and/or the IMU during movement by the motorized system, a capturing by the tracking system of the position and/or orientation of the IMU during a movement of the medical instrument is no longer desired in order to prevent visibility problems. The trained AI system is therefore used to calculate/estimate/predict the position and/or orientation of the IMU from the captured movement data of the IMU.

Preferably, in the step of capturing the position and/or orientation of the IMU by the tracking system, the position and/or orientation of the IMU is captured by an optical tracking system and/or a mechanical-kinematic-based tracking system. The optical tracking system captures the position and/or orientation of the IMU using one or more cameras. The mechanical kinematic-based tracking system captures the position and/or orientation of the IMU, for example by sensors and/or actuators, preferably servomotors, of the motorized system, for example in a robot system by a joint angle sensor between robot arm segments with the use of a kinematic model of the robot. The (global) position and/or orientation of the IMU can be captured by the tracking system with sufficient accuracy. In particular, this step takes place in a controlled environment in which there is always good visual contact between a camera of the optical tracking system and the tracked IMU and, for example, other rigid trackers (such as IR markers) are attached to enable precise measurement. Once the AI system is trained these trackers are no longer required and the IMU can be used in a difficult environment.

Preferably, in the step of linking, the measured movement data are assigned at a first point in time, in particular at a large number of discrete points in time, preferably with defined time intervals, to the captured position and/or orientation at the first point in time. Both the captured movement data and the captured position and/or orientation are time-dependent. Due to this time dependency, also a position and/or orientation can be assigned to a movement at any time. This allows the linked training data set to be generated. In particular, a first position and orientation, i.e.

position at a first point in time, and a second position together with a measured acceleration and rotation rate of the IMU at the first point in time can be linked as a data set. The AI system then independently finds a link through the training, so to speak, in order to deduce the second position from the first position based on the measured movement data and imitate the tracking system.

Preferably, the step of moving involves a movement of the IMU by a robot, and preferably the step of capturing involves capturing by a robotic kinematic tracking system. If the IMU is attached to or on a moving robot arm, the position and/or orientation of the IMU can be captured by the robot's own sensors and/or actuators. This eliminates the need for complex and expensive cameras as in case of an optical tracking system and also avoids line-of-sight problems.

Preferably, the steps of capturing the measured movement data, capturing the position and/or orientation of the IMU and linking them are performed at discrete points in time. The values are captured at specific time intervals. This makes it easier to link the captured data, as although in theory, a continuous measurement can take place, discrete time measurements are always used in practice, even for a corresponding determination.

Preferably, the measured movement data has three acceleration values in three directions and three orientation values around three axes and the AI system has at least six nodes in the input layer. Six values are captured when recording the measured movement data of the IMU. The acceleration in three directions and the orientation in three directions. Since the six values act as input for the AI system, the AI system preferably has six nodes in the input layer. This means that the movement data can be input directly into the AI system without prior conversion.

Preferably, an artificial neural network is used as the AI system, in particular a recurrent deep neural network, especially preferably a long short-term memory network (LSTM network) and/or a convolutional recurrent network. In particular, this allows a depth of the neural network to be adapted and training to be performed until a sufficiently accurate weighting is achieved. The captured data is time-dependent in each case. The aforementioned artificial neural networks are particularly adapted to be trained with time-dependent data.

Preferably, the step of moving along the at least one trajectory, here a predefined trajectory, preferably at least two predefined trajectories, has a changing speed and/or a changing acceleration and/or a changing orientation. In order to collect sufficient training data, the trajectory or the pluralities of trajectories are moved at different speeds, accelerations and/or orientations.

Preferably, in the output step, a (corrected) speed and/or a corrected acceleration of the IMU is output in addition to the position and/or orientation. The trained AI system is essentially a calibration of the IMU in order to determine and output at least a position and/or orientation and moreover a corrected acceleration (approximated to the actual acceleration) and also a (corrected) speed from measured movement data. By calibrating or filtering the raw captured movement values, the raw movement values are corrected. Specifically, the trained AI system outputs such corrected movement data adjusted for the effects of gravitational acceleration or the calibration of the sensors. The corrected movement values can also be output by the AI system. This provides the control unit with corrected values that can be continued to be used as required. The speed of the IMU is output by the trained AI system without the errors that would occur in case of an integration from the raw acceleration data. In particular, the AI system can be trained not only on the relationship between movement data (with acceleration and rotation rate) and position and/or orientation, but also between movement data (with acceleration and rotation rate or rotation rate) and acceleration and orientation or rotation rate.

Preferably, the output position and/or orientation has three position coordinates and/or three orientation coordinates or angular coordinates. In order to know the exact position of the IMU in space, at least three position coordinates must be output by the AI system. The same applies to the orientation. In order to be able to output these values, the AI system should have at least three nodes in the output layer. This allows the position and/or orientation to be output directly. No conversion of the values is required. It is of course conceivable that the AI system has six nodes in its output layer. In this case, the AI system could output three orientations and three positions.

Preferably, a movement is performed along a second trajectory (different from the first). In order to collect as much training data as possible, preferably more than one trajectory is run and the position and/or orientation during the plurality of trajectories is captured by the tracking system.

Preferably, the motorized system can be a robot, in particular a robot arm, which guides the IMU. The IMU can be moved along the trajectory by the robot.

Preferably, the tracking system can have or be an optical tracking system or a kinematics-based tracking system.

Preferably, the IMU captures the measured movement data, at least an acceleration and an orientation, and preferably an orientation to a magnetic field.

Preferably, the IMU is fastened to the motorized system and is moved with it along the trajectory. During the movement, the IMU captures the movement data.

Preferably, the measured movement data are captured by the IMU, preferably three acceleration values in three directions and three orientation values around three axes, and the AI system has at least six nodes in the input layer.

Preferably, the measured movement data are assigned to the captured position by the control unit and/or orientation at the first point in time. The assignment generates the linked training data set.

Preferably, the AI system of the training system is an artificial neural network, in particular a recurrent deep neural network, particularly preferably a long short-term memory network (LSTM network) and/or a convolutional recurrent network. These networks are particularly suited for processing time-dependent data.

Preferably, the AI system has three or six nodes in its output layer.

Preferably, the medical instrument can be an endoscope, preferably a rigid endoscope, which has the IMU in particular in a handle and/or in a distal tip. The IMU captures the movement data during the movement of the medical instrument. The captured movement data are the input for the trained AI system. When the endoscope is inserted into the opening of a patient's body and is moved at the same time, the IMU captures the movement data of the movement.

Preferably, the medical instrument is a gait analysis system comprising at least one IMU, in particular on a knee and/or on a hip and/or on a foot of a propositus. The IMU is fastened to the gait analysis system in such a way that it can capture the movement of the patient during an intervention (actively moved by a doctor, for example) or of a test subject during walking. During walking, the IMU captures the movement data.

Preferably, the medical instrument is a moving surgical robot having the IMU at its distal tip, in particular at a distal tip of a medical end effector.

Any disclosure in connection with the method according to the present disclosure likewise applies to the training system and the medical instrument, as well as any disclosure related to the training system and the medical instrument of the present disclosure also applies to the method of the present disclosure.

### BRIEF DESCRIPTION OF THE DRAWINGS

The disclosure is explained in more detail below by reference to preferred embodiments with the aid of figures, wherein:

FIG. 1 is a schematic front view of a training system according to a preferred embodiment of the present disclosure, which moves an IMU provided at a distal tip from a first position along a trajectory to a second position;

FIG. 2 is a schematic view of a training system of a further preferred embodiment of the present disclosure comprising an optical tracking system and an actively moving IMU;

FIG. 3 is a schematic perspective view of a medical instrument according to a preferred embodiment of the present disclosure in the form of a rigid endoscope;

FIG. 4 is a flowchart of a method according to a preferred embodiment of the present disclosure;

FIG. 5a shows an exemplary time-dependent course of an input value for an AI system; and

FIG. 5b shows an exemplary time-dependent course of an output value of the AI system based on the input value of FIG. 5a.

The figures are schematic in nature and merely serve for comprehension of the disclosure. Identical elements are provided with the same reference signs. The features of the various embodiments can be interchanged.

### DETAILED DESCRIPTION

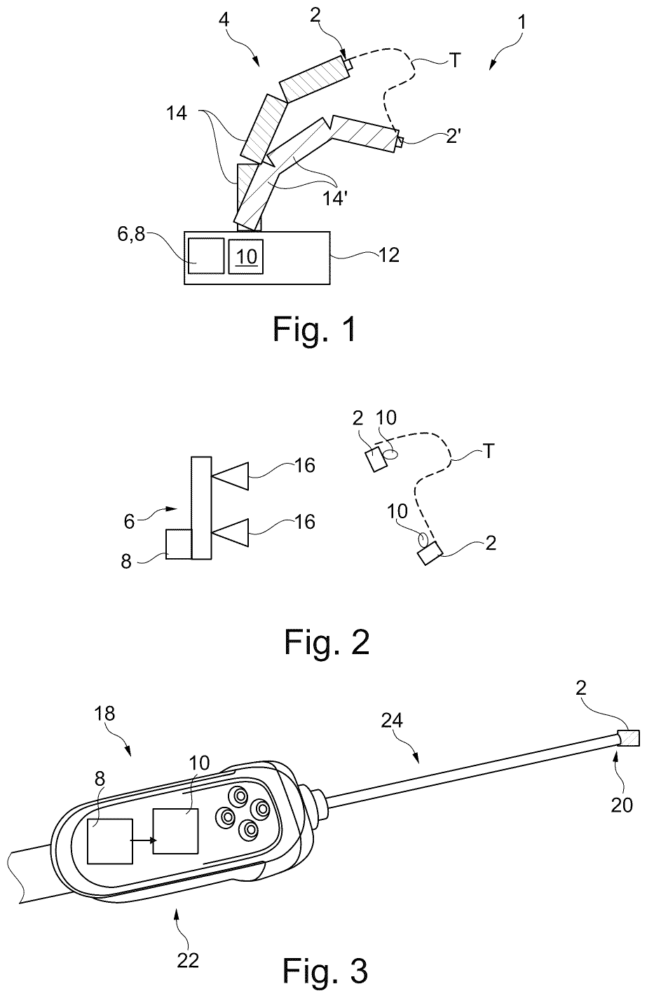

FIG. 1 shows a schematic representation of a training system 1 according to a preferred embodiment of the present disclosure. The training system 1 has an inertial measurement unit (IMU; hereinafter only referred to as IMU) 2, to which an IMU calibration and an assignment of movement data to a position and orientation are to be carried out. For this purpose, the training system 1 has a motorized system 4 in the form of a robot, which is adapted to actively move the IMU 2. The IMU 2 is a sensor set that captures movement data, preferably acceleration and orientation. In this embodiment, the IMU 2 has acceleration and gyro sensors (not shown) in order to capture both (three-dimensional) acceleration (in all spatial directions) and rotation rates around three axes and thus the orientation of the IMU 2 in space as measured movement data.

Specifically, the IMU 2 is fastened to a distal tip of the motorized system 4. The motorized system 4 moves the IMU 2 along a predefined trajectory T through space. During movement by the motorized system 4, the IMU 2 captures the movement data for the predefined trajectory T. In FIG. 1, two different positions of the robot at two different times are shown with different hatching for better clarity.

Furthermore, the training system 1 in FIG. 1 has a tracking system 6 in the form of a mechanical kinematics-based tracking system 6. The motorized system 2 has actuators, in this case servomotors, which set the position of the IMU very precisely and can also be read out using appropriate knowledge of the kinematic model. Specifically, the motorized system 4 is a robot with a movable robot arm connected to a fixed robot base 12, which has several robot arm segments 14 that can move relative to each other and which allow a joint angle to be set between the individual robot arm segments 14. In this way, the position and orientation, i.e. the position, of the IMU 2 can be measured by the robot's internal tracking system 6.

Moreover, the training system has a control unit 8 and an AI system 10. Both the measured movement data and the position and orientation captured by the tracking system 6 are provided to the control unit 8. The control unit 8 links the movement data captured by the IMU 2 and the position and/or orientation of the IMU 2 captured by the tracking system 6 to form a linked training data set. This training data set is used to train the AI system 10 in order to obtain an IMU calibration of movement data on position and orientation. In this embodiment, the AI system 10 of the training system 1 is an artificial neural network, specifically a recurrent deep neural network, in particular a long short-term memory network and/or a convolutional recurrent network. This recurrent deep neural network is particularly suitable for time-dependent data, such as the one captured by the IMU in the present case.

The training system 1 therefore trains the AI system by the control unit controlling the robot so that it moves the IMU along several (in particular predefined) trajectories with changing accelerations (thus changing speeds), different translational movements in different directions and rotations or different orientations. By the variations in both acceleration, direction and orientation particularly detailed training data sets can be generated that can be used to train the AI system. In particular, the IMU 2 is fastened detachably to the distal tip of the motorized system 2, is moved along one or more trajectories until a sufficiently detailed training data set was created for the AI system to be trained, and then the trained AI system is stored on the IMU, in particular on a computer-readable storage medium, in order to establish a bijective IMU calibration for the individual IMU 2. The IMU 2 is finally removed from the training system 1 and can be inserted into a medical instrument (see FIG. 3).

In this way, several IMUs 2 can be individually calibrated one after the other. Those IMUs 2 together with the associated AI system 10 then provide a particularly precise individual assignment of movement data to position and orientation, which can be used in a surgical application.

The training system 1 can thus be used to calibrate the IMU and assign movement data to position and orientation, regardless of the subsequent operating environment. Once the AI system is trained for the IMU 2, the IMU 2 can be used together with the associated AI system 10. Thus, a two-stage system is provided. In the first stage, the training system 1 trains the AI system and thus calibrates the IMU, and in the second, separate stage, the IMU is used with a position and orientation that can be determined with sufficient accuracy based on the measured movement data in order to perform navigation even without an external (global) tracking system. The trained AI system 10 therefore imitates a tracking system. This makes it possible to perform precise navigation entirely without an external tracking system.

In particular, the trained AI system 10 and the IMU 2 can of course also be integrated into a navigation system including a tracking system, and in addition to the position and orientation determined by the tracking system, the position and orientation can also be determined by the trained AI system 10 and the IMU 2. This means that, for example, in the case of an optical tracking system, the trained AI system 10 and the IMU 2 can continue to determine the position and orientation if the line of sight is interrupted, and the optical tracking system can resume determination when a line of sight is re-established.

FIG. 2 shows a schematic view of a training system 1 according to a further, second preferred embodiment of the present disclosure. In contrast to the training system 1 of FIG. 1, the training system 1 as motorized system 4 and tracking system 6 does not have a robot, but a general motorized system (not shown here) and an optical tracking system 6. This optical tracking system 6 has several spaced-apart cameras 16 in order to enable three-dimensional spatial detection, in particular by triangulation, by means of image analysis of the tracking system 6, in particular by the control unit 8. The cameras 16 are arranged in such a way that they track the IMU 2 along the trajectory T in space and (via corresponding determination by the tracking system 6) capture the position and orientation of the IMU 2 in space. This position and orientation captured during the movement is then provided to the control unit 8.

The control unit 8 links the measured movement data captured by the IMU 2 and the position and/or orientation of the IMU 2 captured by the tracking system 6 to form a linked training data set. The AI system 10 is trained using the training data set. In this embodiment, the AI system 10 again is an artificial neural network in the form of a recurrent deep neural network, in particular a long short-term memory network and/or a convolutional recurrent network. The AI system 10 to be trained has six input nodes for an input of three acceleration values measured by the IMU 2 and three measured rotation rates or angular velocities. Furthermore, the AI system has six output nodes, wherein three output nodes have three position coordinates and three output nodes have three orientation coordinates (in this case angular coordinates). In this embodiment, the control unit 8 and the AI system 10 to be trained are connected to each other via a wireless data connection, such as WLAN or Bluetooth, so that the IMU 2 and the AI system 10 form a uniform module, so to speak, which can later be inserted in an isolated manner in a medical instrument.

FIG. 3 shows a perspective view of a medical instrument 18 according to a preferred embodiment of the present disclosure. In the present embodiment, the medical instrument 18 is configured as a rigid endoscope and has the IMU 2 at its distal tip and the control unit 8 and the trained AI system 10 in a handle.

When the medical instrument 18 in the form of the endoscope is moved in the body of a patient (not shown), the (global) position of the distal tip 20 cannot be captured by the optical tracking system of a navigation system. Therefore, the position of the medical instrument is determined via the IMU 2, which is fastened to the distal tip of the medical instrument 18. The position of the IMU 2 is determined on the basis of the measured movement data of the IMU 2. During the movement of the medical instrument 18, the IMU 2 captures the movement data. The control unit 8 is provided with the captured movement data, which uses it as input for the AI system 10 (trained on the IMU 2). The trained AI system 10 outputs a determination/prediction or a very accurate estimate of the position and/or orientation of the IMU 2 and thus of the distal tip 20 of the medical instrument 18 based on the captured movement data. In particular, the medical instrument may comprise an IMU 2 with associated AI system 10 trained by the training system 1 of the present disclosure.

In FIG. 3, the medical instrument 18 is configured as an endoscope. However, it is also conceivable that the medical instrument 18 be configured as a system for gait analysis or as a movable surgical robot with end effector (in each case not shown).

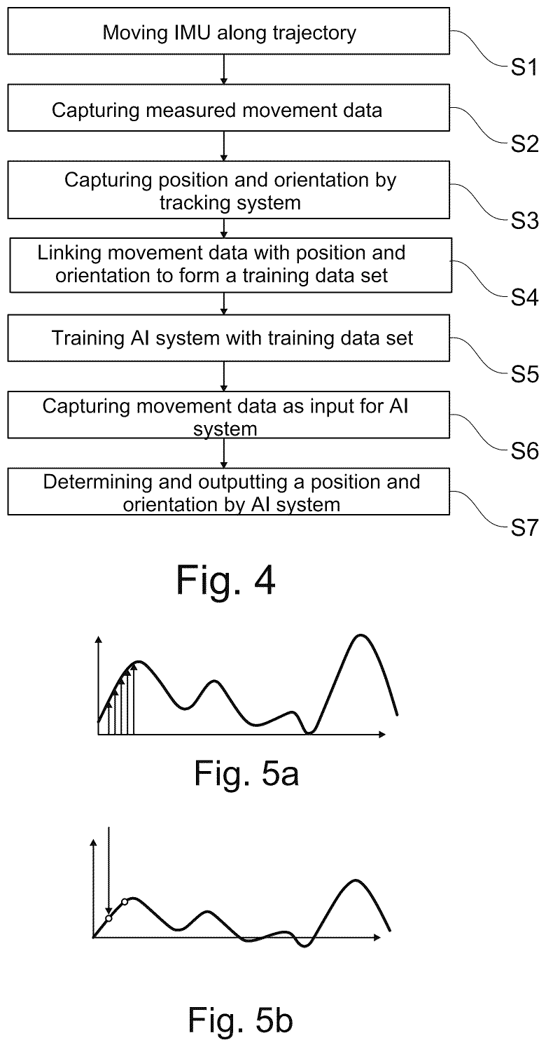

FIG. 4 shows a flow chart of a method according to a preferred embodiment of the present disclosure.

In a first step S1, the IMU 2 is moved along the predefined trajectory T by the motorized system 4.

During the movement of the IMU 2, the movement data, in this case acceleration and orientation, are captured by the IMU 2 in a step S2.

At the same time, the position and orientation of the IMU 2 are captured in a step 3 by the (external) tracking system 6. The control unit 8 is provided with the captured movement data and the captured position and orientation of the IMU 2.

In step S4, the control unit 8 links the captured movement data and the captured position and/or orientation. The associated movement data is assigned to each position and orientation in terms of time. This generates a training data set.

In a further step S5, the AI system 10 is trained using the generated training data set. The trained AI system 10 is essentially an IMU calibration for the captured movement data in order to obtain an assignment of movement data to position and orientation. With step S5, the training of the AI system is completed preliminarily or finally.

In particular, the IMU 2, in an intermediate step, is then provided on a medical instrument 18 (see, for example, FIG. 3), such as a rigid endoscope. Also a data connection between the medical instrument or the control unit and the trained AI system is provided. Preferably, the trained system is integrated in the medical instrument.

In a further step S6, the IMU 2 then captures movement data that preferably belong to a trajectory other than the (in particular predefined) trajectory T traveled during training. The captured movement data are the input for the trained AI system 10. In a final step S7, the trained AI system 10 outputs the position and orientation of the IMU 2 on the basis of the captured movement data and thus imitates the tracking system.

FIGS. 5a and 5b serve to further explain a correlation between the input and output values of the AI system 10. FIG. 5a shows a time curve of a measured variable of the IMU 2. In reality, three orientations and three accelerations are captured by the IMU 2 as movement data and are used as input for the AI system 10. Based on these inputs, the trained AI system 10 outputs values. An example of such a curve of an output value is shown in FIG. 5b. For simplifying the illustration, only one output value is illustrated. In the present case, for example, FIG. 5a may show an acceleration in the X direction (a_x) and FIG. 5b may show a position coordinate in the X direction (r_x). Alternatively, FIG. 5a may show an orientation around an axis and FIG. 5b a corrected orientation around the axis. In reality, three positions or three orientations are output. The courses of the input and output values are time-dependent. During the movement of the IMU 2, new data is entered into the AI system 10 in real time and, based thereon, corresponding values are output by the trained AI system. As the two captured data sets are time-dependent, it is therefore possible to assign a position to a set of movement data at a specific point in time.

With the aid of the present disclosure an (arbitrary) inertial measurement unit can therefore be used, which is calibrated prior to an actual use through training of an AI system to the effect that the trained AI system, as a type of translator or imitator of a tracking system based on internal measured values of the IMU (movement data), can later determine at least one position and/or orientation with sufficient accuracy and, in particular, eliminate global errors and deviations of the IMU 2, for example due to production, in advance.

### LIST OF REFERENCE SYMBOLS

1 Training system
2, 2′ inertial measurement unit (IMU)
4 Motorized system
6 Tracking system
8 Control unit
10 AI system
12 Robot base
14 Limb/robot arm segment
16 Camera
18 Medical instrument
20 Distal tip
T Trajectory
S1 Step Move IMU along trajectory
   S2 Step Capture measured movement data
   S3 Step Capture position and orientation by tracking system
   S4 Step Link movement data with position and orientation to form a training data set
   S5 Step Train AI system with training data set
   S6 Step Capture movement data as input for AI system
   S7 Determine and output a position and orientation by AI system

1.-15. (canceled)

16. A method for calibrating and determining at least one position and/or orientation of an inertial measurement unit, the method comprising the steps of:
moving the inertial measurement unit by a robot along a trajectory in space;
capturing, during movement, movement data by the inertial measurement unit and providing the movement data to a control unit;
capturing, during movement, a position and/or orientation of the inertial measurement unit by a tracking system;
linking the movement data to the position and/or orientation in order to obtain a training data set;
training an AI system with the training data set to obtain an IMU calibration of said captured movement data to said captured position and/or orientation;
capturing movement data of the inertial measurement unit as an input to the trained AI system, and
determining and outputting, based on the input movement data, a position and/or orientation of the inertial measurement unit by the trained AI system.

17. The method according to claim 16, wherein, in the step of capturing movement data, at least one acceleration and one orientation are captured.

18. The method according to claim 17, wherein the movement data comprises the at least one acceleration and at least one rotation rate.

19. The method according to claim 16, wherein, in the step of linking the captured movement data to the captured position and/or orientation, the movement data are assigned at a first point in time to the captured position and/or orientation at the first point in time.

20. The method according to claim 16, wherein the step of moving comprises a movement of the inertial measurement unit by the robot.

21. The method according to claim 16, wherein the step of capturing comprises a capturing of the position and/or orientation of the inertial measurement unit by a robotic kinematic tracking system.

22. The method according to claim 16, wherein the movement data includes three acceleration values in three directions and three rotation rate values or three orientation values about three axes and the AI system comprises at least six nodes in an input layer.

23. The method according to claim 16, wherein an artificial neural network is used as the AI system.

24. The method according to claim 23, wherein the artificial neural network is a recurrent deep neural network, a long short-term memory network or a convolutional recurrent network.

25. The method according to claim 16, wherein the step of moving takes place along a predefined trajectory, and the robot changes speed and/or acceleration and/or rotation rate or orientation during the movement.

26. The method according to claim 16, wherein in the step of determining and outputting, in addition to the position and/or orientation, a corrected acceleration and/or a corrected speed of the inertial measurement unit is output.

27. A training system for calibrating and determining at least one position and/or orientation of an inertial measurement unit, comprising:
an inertial measurement unit to be calibrated, which captures movement data and provides it to a control unit;
a robot which is adapted to move the inertial measurement unit to be calibrated along a trajectory in space;
a tracking system, which is adapted to capture a position and/or orientation of the inertial measurement unit and to provide it to the control unit;
a control unit linking the captured movement data with the captured position and/or orientation to obtain a training data set; and
an AI system which is trained by the control unit with the training data set to obtain a trained AI system with an IMU calibration of movement data on position and/or orientation.

28. The training system according to claim 27, wherein the tracking system comprises an optical tracking system.

29. The training system according to claim 27, wherein the tracking system comprises a mechanical kinematic-based tracking system.

30. A medical instrument comprising an inertial measurement unit and a trained AI system,
wherein the trained AI system is trained by a training system in order to obtain a position and/or orientation of the inertial measurement unit,
wherein captured movement data of the inertial measurement unit is an input for the trained AI system.

31. The medical instrument according to claim 30, wherein the medical instrument is an endoscope, which comprises the inertial measurement unit.

32. The medical instrument according to claim 30, wherein the medical instrument is a gait analysis system comprising at least one inertial measurement unit.

33. The medical instrument according to claim 32, wherein the at least one inertial measurement unit is positioned on a knee and/or on a hip and/or on a foot of a subject.
